(19) United States
(12) Patent Application Publication
(10) Pub. No.: US 2014/0008341 A1
(43) Pub. Date: Jan. 9, 2014

(54) METHOD FOR TREATING A WORK PIECE

(71) Applicant: Rollomatic S.A., Le Landeron (CH)

(72) Inventor: Christian KRUMM, Cortebert (CH)

(21) Appl. No.: 13/933,169

(22) Filed: Jul. 2, 2013

(30) Foreign Application Priority Data
Jul. 6, 2012 (EP) 12005022.4

(51) Int. Cl. B23K 26/38

(52) U.S. Cl. CPC B23K 26/38
USPC 219/121.78

(57) ABSTRACT

A method for machining a workpiece is proposed where a laser beam and/or a workpiece are moved relative to each other and a cutting edge is produced on the workpiece by means of the removal of material by laser ablation. First, initial alignment of the workpiece (1) and/or the laser beam (2) relative to each is performed. Then an initial removal of material from the workpiece (1) by the laser beam (2) is carried out. An initial section (4) of the workpiece (1) is removed. Then the alignment of the workpiece (1) and laser beam (2) relative to each other is changed. The second alignment process performed differs from the first alignment process of the workpiece (1) and laser beam (2) relative to each other. In a second removal of material from the workpiece (1) a second section (12, 18, 24) of the workpiece (1) is removed with the laser beam (2′, 2″, 2′″). The cutting edge (16, 23, 29) is produced at the end of the second material removal process.

The invention derives from a method for machining a workpiece where a laser beam and a workpiece are moved relative to each other and a cutting edge is produced by means of the removal of material.

The machining of workpieces by means of short, intensive laser pulses is known. Laser radiation at high power density causes the material on the surface of the workpiece to heat up. Depending on the power density, plasma may form on the surface of the workpiece. Material is removed from the surface of the workpiece in the process. This is referred to as laser ablation.

The laser beam and workpiece are moved relative to each other in a defined manner in order to remove material specifically within defined sections of the workpiece and to give the workpiece particular contours. This process includes in particular producing blades on workpieces. They are also referred to as cutting edges. These consist of a geometrically defined blade for cutting materials, in particular by chip removal methods. Here, pieces of material in the form of chips are mechanically separated from a workpiece by the cutting action of a tool. The shape of the cutting wedge and the edge radius of the cutting edge are determined by the geometry of the blade. The cutting wedge preferably takes a form that gives it maximum stability while optimizing chip formation and chip removal.

The cutting edge is the edge of the cutting wedge which is formed by a cutting face and an open face. The angle between the cutting face and the open face is referred to as the wedge angle. It is normally less than 120°.

To produce a cutting wedge on a workpiece, the laser beam can be directed at a first side surface of the workpiece and material removed from a section of the first side surface, layer by layer. A second side surface of the workpiece is formed adjacent to the section of the first side surface that was not removed. The second side surface is then the open face. The section of the first side surface that was not removed is the cutting face. Conversely, the second side surface may also be the cutting face and the section of the first side surface that was not removed the open face. The cutting face and the open face delimit the cutting wedge. The angle between the open face and the cutting face is referred to as the wedge angle. The edge formed by the open face and the cutting face is the cutting edge.

A disadvantage here is that the cutting edge produced starting with the first side surface by means of laser ablation exhibits a large edge radius. This is independent of the size of the wedge angle. The cutting edge does not exhibit the necessary sharp structure.

It is therefore the object of the present invention to provide an improved method of machining workpieces, by means of which cutting edges with a small edge radius and high edge sharpness are produced.

This objective is achieved with a method according to claim 1. To that end the workpiece and/or the laser beam are aligned for a first time. A first side surface of the workpiece is arranged to face the laser beam. Material is then removed from the workpiece by the laser beam. This initial removal of materials begins preferably in a first section of the first side surface. The material is removed layer by layer. A first section of the workpiece is removed entirely layer by layer. As a result, the first section of the first side surface and the material beneath it disappear preferably entirely. The removal of material results in a new second side surface, which may be adjacent to a second section of the first side surface remaining after the removal of material. In this instance the second side surface and the second section of the first side surface form a common edge. The second side surface and the second section of the first side surface confine an angle β.

After the first removal of material, the alignment of the workpiece and laser beam relative to each other is changed. Alignment for the second time of the workpiece and/or laser beam relative to each other takes place. The position of workpiece and laser beam relative to each other after alignment for the second time now differs from the position after alignment for the first time. To achieve this, either the alignment of the workpiece or the alignment of the laser beam or both can be altered. Workpiece and laser beam are aligned with each other in such a way that the first side surface or the second side surface of the workpiece faces the laser beam. A second removal of material from the workpiece by the laser beam then takes place. In the preferred form, removal begins either in a first section of the second side surface and extends up to the second section of the first side surface or it begins in the second section of the first side surface and extends up to a first section of the second side surface. A second section of the workpiece is removed. The first section of the second side surface, part of the second section of the first side surface and the material beneath it now disappear. Only a remnant of the second section of the first side surface, referred to as the third section, remains after the second removal of material. Only a remnant of the second side surface, referred to as the second section of the second side surface, remains after the second removal of material.

The second removal of material produces a new third side surface which may be adjacent to a third section remaining on the first side surface after the second removal of material and may be adjacent to the second section of the second side surface.

For the first and second removal of material, the laser beam is directed at the side surface on which the appropriate material removal process begins, with its beam axis at an angle of δ<β. Here, β is the angle between the side surface on which the removal of material begins and the side surface produced by the removal of material. The laser beam exhibits a central beam axis and a beam opening angle. The laser beam relative to the side surface of the workpiece is set in relation to its central beam axis. The fact that the laser beam confines the angle δ<β with the side surface on which the removal of material begins favors the removal of material layer by layer and the creation of a new side surface which confines the angle β with the side surface on which the removal of material begins. The section that is eliminated with the removal of material is removed layer by layer rather than cut off.

The angle δ during the first and second material removal process is measured at the side surface on which the removal of material begins. It is measured starting from the section of the side surface on which the material is removed.

Because the beam axis of the laser beam is angled towards the side surface to be produced during the removal of material, this can be produced with greater precision than if angle δ corresponds to angle β. This is especially the case because the new side surface is produced not by cutting away part of the workpiece but by a section of the workpiece being removed entirely layer by layer.

For the layer-by-layer removal of material, the laser beam is moved relative to the surface of the workpiece with the result that a section of the workpiece is removed in entirety by laser ablation. Angle δ is essentially preserved until the entire section has been removed.

The edge that is formed on the third side surface at the end of the second material removal process is the cutting edge. If the second material removal process begins on the second side surface and ends on the first side surface, the cutting edge is the edge between the third side surface and the first side surface—to be precise, the edge between the third side surface and the third section of the first side surface. If the second material removal process begins on the first side surface, the cutting edge is the edge between the third side surface and the second side surface—to be precise, between the third side surface and the second section of the second side surface. The two side surfaces adjacent to the cutting edge delimit the wedge angle. One of the two side surfaces is the cutting face and the other is the open face.

It is beneficial that the workpiece is arranged for machining according to the method on a workpiece carrier.

In the method according to the invention the workpiece is first machined with the laser beam, starting with a first side surface of the workpiece. If it is assumed that the first side surface of the workpiece is the front surface, the first material removal process takes place from the front. This results in the formation of a new second side surface which confines an angle β together with the remainder of the first side surface. The alignment of workpiece and/or laser beam relative to each other is then adjusted in such a way that machining of the workpiece can take place from behind or from the side. Machining begins on the new second side surface and ends on the first side surface or vice-versa. This results in the formation of a new third side surface. As a result of machining from behind or from the side, the cutting edge is produced at the end of the second material removal process, not at its start. It therefore exhibits a significantly smaller edge radius than with known methods where the cutting edge is produced from the front at the start of a material removal process.

Because the cutting edge is not formed until the end of the second material removal process, inaccuracies in the positioning of the laser beam on the second side surface at the start of the second material removal process, deviations in the angle at which the laser beam is directed at the second or first side surface and the material beneath it, and special features of the beam geometry may affect the position of the cutting edge on the third side surface. This effect can be minimized by less material being removed in the second material removal process than in the first.

The order of processing and the production of a second side surface from the front and then of a third side surface from the rear not only produces a very sharp cutting edge. It also means that the cutting edge is produced in a precisely defined position. This applies in particular where the length of the third side surface that is perpendicular to the cutting edge to be produced is short compared with the length of the second side surface that is perpendicular to the edge between the second side surface and the second section of the first side surface. This length of the third side surface may be less than half the length of the second side surface, but preferably less than a quarter and most preferably less than an eighth of the length of the second side surface. Even where there are small deviations in the angle between the third side surface and the second side surface or between the third side surface and the first side surface, the position of the cutting edge is precisely within specified tolerance limits.

According to an advantageous embodiment of the invention, angle δ is smaller than or equal to the difference between angle β and angle θ/2. Therefore δ≦β−θ/2. Here, β is the angle between the side surface on which the removal of material begins and the side surface produced by the removal of material. θ is the opening angle of the laser beam. θ here is the entire opening angle of the cone of the laser beam. θ is halved by the central beam axis of the laser beam. If the laser beam is set to strike the side surface of the workpiece on which material removal begins with its beam axis at an angle of δ≦β−θ/2, the opening angle of the laser beam's beam cone is taken into account in its setting.

According to a further advantageous embodiment of the invention the angle δ in essence corresponds to the difference between angle β and half the opening angle of the laser beam. Therefore δ≈β−θ/2. Angle δ may thus be equal to the difference between β and θ/2 or be slightly smaller or slightly greater. On this small scale, the angle may also change during the removal of material.

According to an advantageous embodiment of the invention, angle β between the second side surface and the second section of the first side surface may be greater than 45° and smaller than 120°.

According to a further advantageous embodiment of the invention, angle α, α₁ or α₂ between the third side surface and the third section of the first side surface and/or angle γ between the third side surface and the second section of the second side surface is greater than 0° and less than 180°. This applies in particular to the wedge angle. If the second material removal process begins on the second side surface and ends on the first side surface, the wedge angle is α. In this case the wedge angle α is limited by the third and the first side surfaces. If the second material removal process begins on the first side surface and ends on the second side surface, the wedge angle is γ. In this case the wedge angle γ is limited by the third side surface and the second side surface.

According to a further advantageous embodiment of the invention the material is removed layer by layer, by means of laser ablation. The section removed from the workpiece to produce a new side surface is removed entirely layer by layer rather than cut off. It can also be removed in sections with the sections not being layers.

According to a further advantageous embodiment of the invention the laser beam is moved over the workpiece by means of beam guidance. The beam guidance ensures that material is removed from the workpiece in a defined manner. In addition the workpiece can be moved. To that end the workpiece carrier on which the workpiece is arranged can be moved by a drive mechanism.

According to a further advantageous embodiment of the invention, in the first material removal process to form the second side surface the material is removed from the first side surface up to a fourth side surface of the workpiece. The fourth side surface faces away from the first side surface of the workpiece.

In other words the first and the fourth side surfaces do not make contact and are not adjacent. They do not exhibit a common edge. The second side surface produced by the first material removal process extends from the first side surface to the fourth side surface. It is adjacent to the first and the fourth side surfaces. The second side surface forms an edge with the first side surface. Furthermore the second side surface forms an edge with the fourth side surface. The two edges may be parallel to each other. The fourth side surface may for example be parallel to the first side surface. In this instance the angle between the fourth and the second side surfaces corresponds to the difference between 180° and β, where β is the angle between the first and the second side surface. The third side surface is not adjacent to the fourth side surface. It therefore does not form a common edge with the fourth side surface. The third side surface is adjacent to the first side surface, in particular to the third section of the first side surface that remains after the first and second material removal process. The third side surface is moreover adjacent to the second section of the second side surface that remains after the second material removal process. This second section of the second side surface is adjacent to the fourth side surface. The second section of the second side surface and the fourth side surface form a common edge. Part of the fourth side surface is removed in the first material removal process. No material is removed from the fourth side surface in the second material removal process.

According to a further advantageous embodiment of the invention the second and the third side surfaces acquire the form of flat surfaces by the removal of material. In addition it is possible to give the second side surface the form of a curved surface in the first material removal process and/or give the third side surface the form of a curved surface in the second material removal process.

According to a further advantageous embodiment of the invention, after the initial removal of material and before the second removal of material the workpiece is turned through an angle of between 60° and 180° relative to the laser beam, about an axis that is essentially perpendicular to the beam axis of the laser beam. This results in the workpiece being turned to the laser beam with the second side surface or the first side surface at a different angle for the first material removal process. As a result the workpiece can be processed from the rear. When rotating it should be considered that the laser beam is not parallel, but has a slightly conical shape. The laser beam exhibits an opening angle θ that is taken into account in aligning the laser relative to the surface of the workpiece.

According to a further advantageous embodiment of the invention less material is removed by the laser beam in the second material removal process than in the first material removal process. As a result, the cutting edge can be positioned precisely between the first and the third side surface. In this case the second section that is removed from the workpiece by laser ablation in the second material removal process is smaller than the first section that is removed from the workpiece by laser ablation in the first material removal process.

Further advantages and advantageous configurations of the invention can be obtained from the following description, the drawing and the claims.

### DRAWING

Three model embodiments of the invention are shown in the drawing. In the drawings:

FIG. 1 Workpiece and laser beam of a first model embodiment in its side view before the first material removal process,

FIG. 2 Workpiece as shown in FIG. 1 in side view after the first material removal process,

FIG. 3 Workpiece and laser beam of the first model embodiment in side view before the second material removal process,

FIG. 4 Workpiece as shown in FIG. 3 in side view after the second material removal process,

FIG. 5 Workpiece as shown in FIG. 1 before the first material removal process in perspective view with the second and third side surface marked,

FIG. 6 Workpiece as shown in FIG. 5 in side view,

FIG. 7 Workpiece as shown in FIG. 4 after the second material removal process in perspective view,

FIG. 8 Workpiece and laser beam of a second model embodiment in its side view after the first material removal process and before the second material removal process,

FIG. 8a Detail of FIG. 8,

FIG. 9 Workpiece and laser beam of a third model embodiment in its side view after the first material removal process and before the second material removal process,

FIG. 10 Workpiece and laser with beam axis and beam opening angle.

### DESCRIPTION OF THE MODEL EMBODIMENTS

FIGS. 1 to 4 show the various steps of the method for machining workpieces in a first model embodiment. FIG. 1 shows a workpiece 1 in a side view before the first material removal process. This is a blank. Here, the workpiece 1 is arranged on a workpiece carrier that is not shown. A laser beam 2 is directed at the workpiece 1. The laser beam is generated by a laser source and directed at the workpiece 1 and guided over the workpiece 1 by means of beam guidance. The laser source and the beam guidance are not shown in the drawing. In FIG. 1 the workpiece 1 is aligned with a first side surface 3 facing upwards. The side surface 3 corresponds to the front surface of the workpiece 1. The laser beam 2 is directed at the workpiece 1 with its beam axis at an angle δ. Here, the angle δ=β−θ/2. β is the angle between the side surface 3 on which the removal of material begins and the side surface 5 produced by the removal of material. θ is the beam opening angle of the laser.

The angle δ during the first and second material removal process is measured at the side surface on which the removal of material begins. It is measured starting from the section of the side surface on which the material is removed. In FIG. 1 this is the first section 7 of the first side surface 3.

In FIG. 10, the laser 30 is shown with its beam axis 31 and its opening cone 32. The opening angle of the beam cone is the beam opening angle θ. The beam axis 31 runs in the centre of the beam cone 32. θ/2 is half the beam opening angle. The beam cone is a straight circular cone. The base is a circle. The central beam axis is a straight line which runs through the centre point of the circular base and through the cone tip. θ/2 corresponds to the angle between the generatrix of the beam cone and the central beam axis. The beam cone is generated by the laser light of the laser 30 and a lens or lens system not shown in the drawing. The lens or lens system is located in the laser housing. The lens or lens system focuses the laser light on the surface of the workpiece 1. It is beneficial that laser 30 and workpiece 1 are arranged such that the focal point is on the surface of the workpiece. When removing material from the workpiece, the focus of the laser beam is guided so that it is permanently on the surface currently to be machined.

In an initial material removal process a section 4 of the workpiece 1 is removed by the laser beam 2 and a new second side surface 5 suggested by a broken line in FIG. 1 is created. To that end, the laser beam 2 is guided relative to the workpiece 1 in order to remove material layer by layer, starting on the first side surface 3 and as far as a fourth side surface 6 facing away from the first side surface 3. The fourth side surface 6 is parallel to the first side surface 1. It corresponds to the rear of the workpiece 1. A first section 7 of the first side surface 3 disappears after the first material removal process. A second section 8 of the first side surface 3 remains. A first section 9 of the fourth side surface 6 disappears after the first material removal process. A second section 10 of the fourth side surface remains.

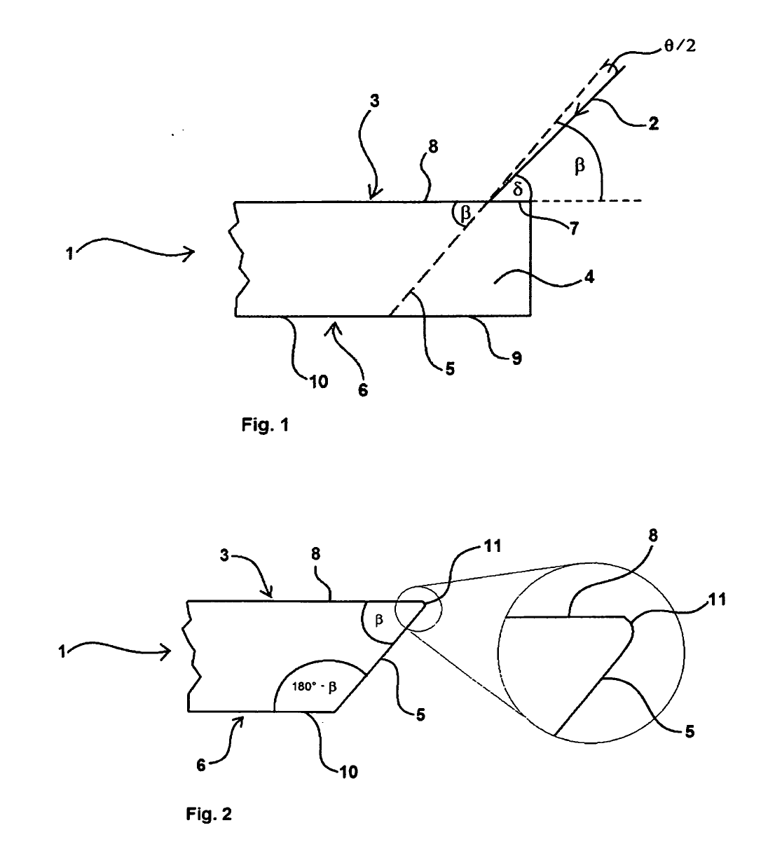

FIG. 2 shows the workpiece 1 after the first material removal process. The section 4 of the workpiece 1 was removed. The workpiece 1 exhibits the new second side surface 5. After the first material removal process the second section 8 of the first side surface of the workpiece remains. After the first material removal process the second section 10 of the fourth side surface remains. The second side surface 5 adjoins the first side surface 3 in its second section 8. The second side surface 5 and the second section 8 of the first side surface 3 form a common edge 11. In addition the second side surface 5 adjoins the fourth side surface 6 in its second section 10. The second side surface 5 and the second section 10 of the fourth side surface form a common edge that is parallel to the edge 11. The second side surface 5 is directly adjacent to the first side surface 3 and to the fourth side surface 6. The second side surface 5 and the second section 8 of the first side surface 3 confine an angle β that is less than 90°. Because the first side surface and the fourth side surface are parallel to each other, the second side surface 5 and the second section 10 of the fourth side surface 6 confine the angle 180° minus β. Because the first material removal process by the laser begins on the first side surface 3, the edge 11 between the second side surface 5 on the one hand and the second section 8 of the first side surface 3 on the other hand exhibits a large edge radius. The edge 11 is therefore rounded off and does not exhibit a sharp edge structure. This is shown enlarged in a detail of FIG. 2.

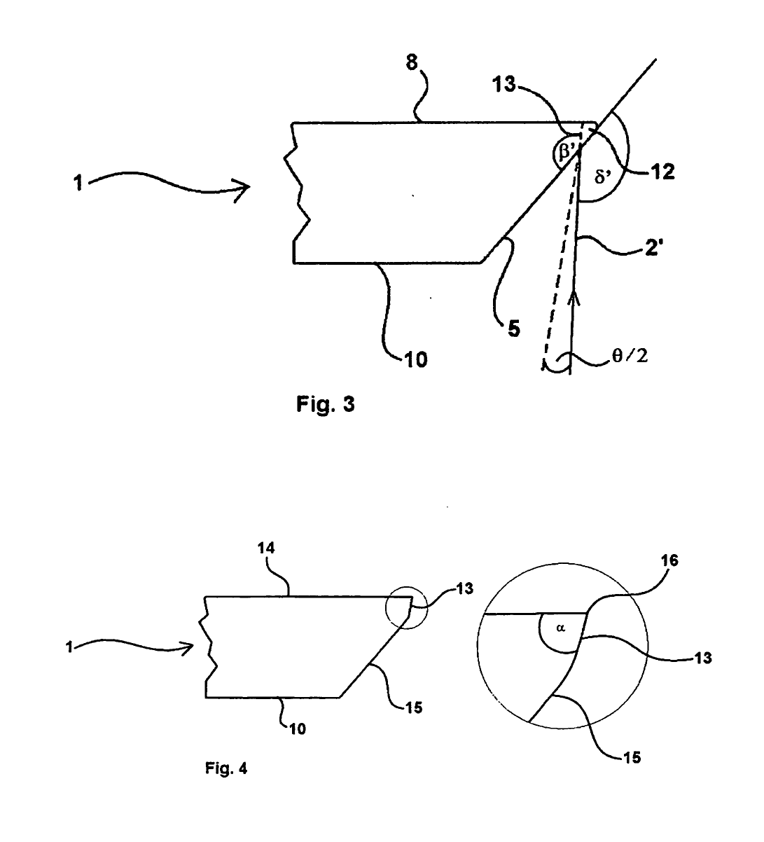

After the first material removal process the alignment of the workpiece 1 and/or the laser beam 2 are changed such that the laser beam strikes a side of the workpiece 1 that faces away from the first side surface 3. As shown in FIG. 3, after adjustment of the alignment the laser beam 2′ strikes the second side surface 5. The laser beam 2′ is directed at the second side surface 5 at an angle

δ′=β′−θ/2.

Here, β′ is the angle between the second side surface 5 on which the second material removal process begins and the third side surface 13 produced by the second material removal process. θ/2 again corresponds to half the beam opening angle of the laser beam.

The laser beam is then guided over the second side surface in order to remove a second section 12 of the workpiece 1 layer by layer in a second material removal process. A first section 17 of the second side surface as well as part of the second section 8 of the first side surface disappears in the process. A third side surface 13, suggested by the broken line in FIG. 3, is produced. The section 12 removed from the workpiece in the second material removal process is significantly smaller than the section 4 removed in the first material removal process.

FIG. 4 shows the workpiece 1 after the second material removal process. The second material removal process begins on the second side surface and ends on the first side surface 3. After the second material removal process there remains a third section 14 of the first side surface 3 and a second section 15 of the second side surface 5 on the workpiece 1. The third side surface 13 is inclined at an angle α to the first side surface 3. Here, α is smaller than 90° and greater than β. The cutting wedge is formed by the third section 14 of the first side surface 3 and by the third side surface 13. α corresponds to the wedge angle, the third section 14 of the first side surface 3 corresponds to the cutting face and the third side surface 13 corresponds to the open face. The third side surface 13 and the third section of the first side surface form a common edge. This is the cutting edge 16. The cutting edge 16 of the cutting wedge exhibits a significantly smaller edge radius than the edge shown in FIG. 2 between the first side surface 3 and the second side surface 5.

The third side surface 13 and the second section of the second side surface 15 are inclined against the first side surface at two different angles. The angle α between the first side surface 3 and the third side surface 13 is greater than the angle β between the first side surface 3 and the second side surface 5. The angle between the third side surface and the second section 15 of the second side surface 5 is 180° minus α plus β.

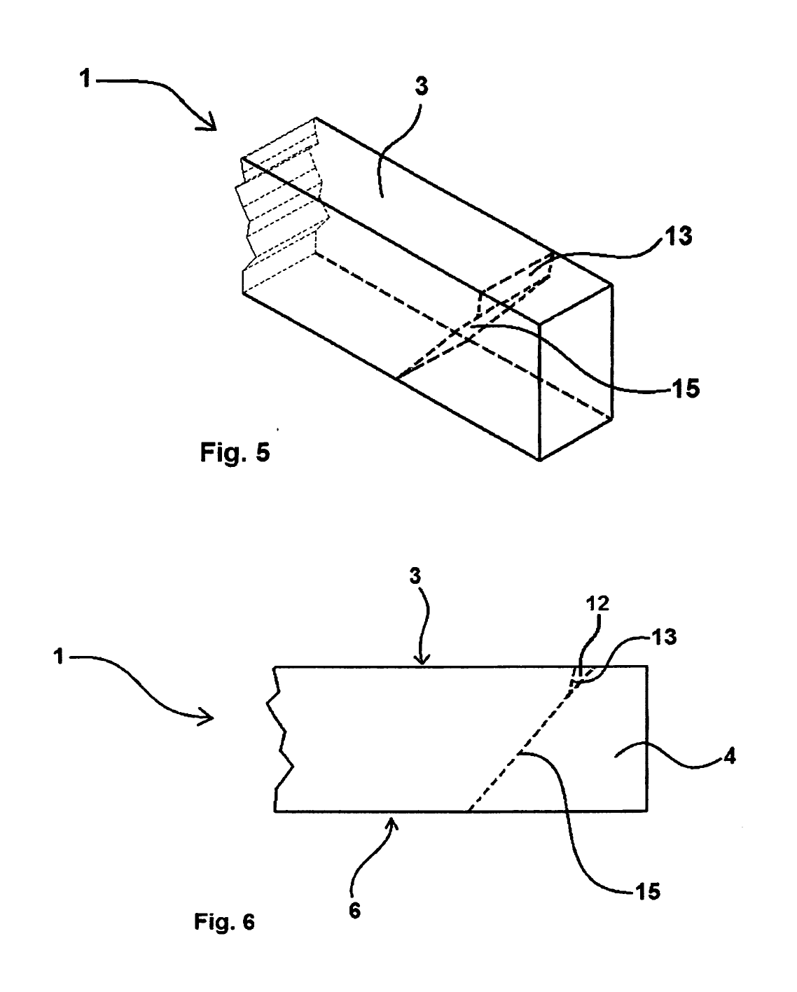

FIGS. 5 and 6 show the workpiece 1 before the first material removal process. The second side surface 5 and the third side surface 13 are suggested.

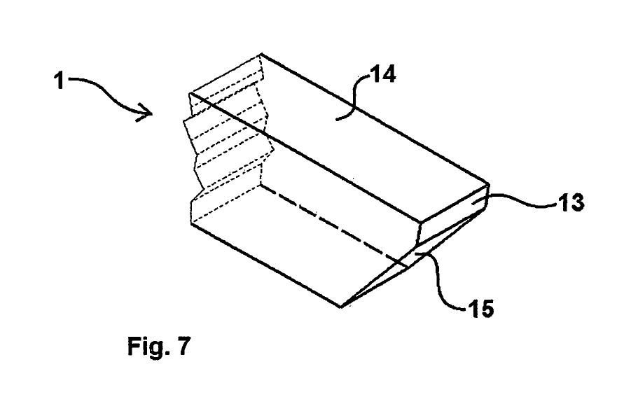

FIG. 7 shows the workpiece 1 in a perspective view after the second material removal process.

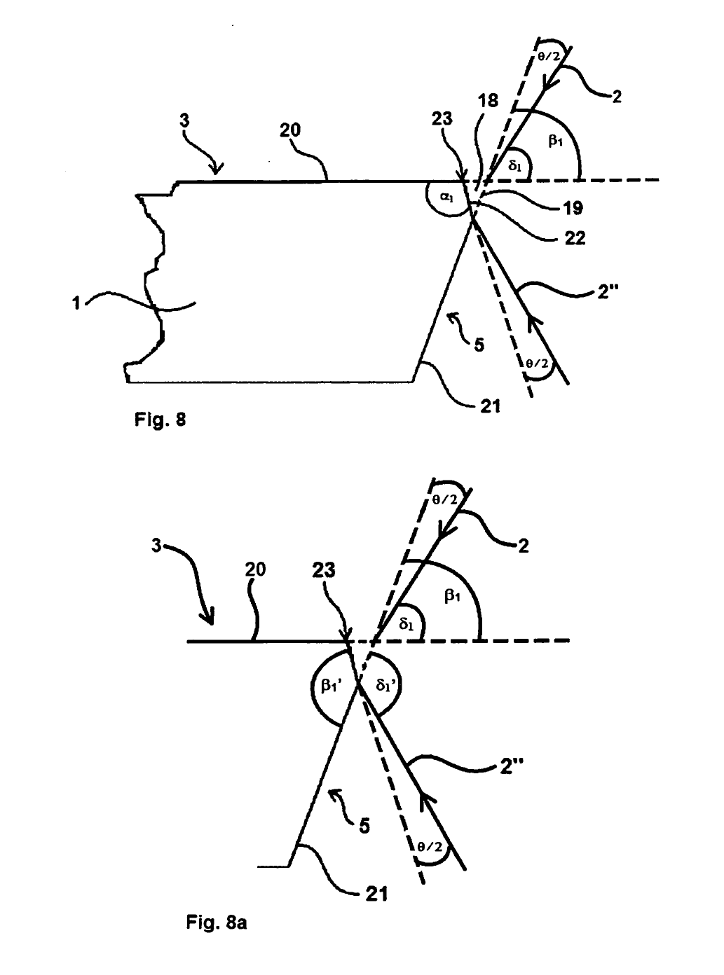

FIG. 8 shows a second model embodiment of the method. With regard to the first material removal process, the second model embodiment corresponds to the first model embodiment. The process steps shown in FIGS. 1 and 2 regarding the initial alignment of workpiece 1 and laser beam 2 and the first material removal process are therefore identical in the second model embodiment. The reference numbers corresponding to those for the first model embodiment are the same as for the first model embodiment in the second model embodiment shown in FIG. 8. In the first material removal process the beam axis of the laser beam 2 is aligned at the angle δ₁=β₁−θ/2 relative to the first side surface 3. β₁ is the angle between the side surface 3 on which the removal of material begins and the side surface 5 produced by the removal of material. θ is the opening angle of the laser. The difference between the first and second model embodiment consists of the second alignment of workpiece 1 and laser beam with each other. After the second alignment the laser beam 2″ strikes the second side surfaced 5 at a different angle δ₁′=β₁′−θ/2 compared with the first model embodiment. In the second model embodiment the second material removal process begins on the second side surface 5 and ends on the first side surface 3. In the second material removal process a second section 18 of the workpiece 1 is removed. Part of the second section of the first side surface 3 and an initial section 19 of the second side surface 5 now disappears. There remains a third section 20 of the first side surface and a second section 21 of the second side surface 5. A new third side surface 22 which is adjacent to the third section 20 of the first side surface and to the second section 21 of the second side surface 5 furthermore forms. The edge between the third side surface 22 and the third section 20 of the first side surface is produced at the end of the second material removal process. This is the cutting edge 23. The angle α₁ between the first side surface 3 and the third side surface 22 is greater than 90°.

FIG. 8a shows a detail of FIG. 8. The angles δ₁′ and δ₁′ are shown in this detail.

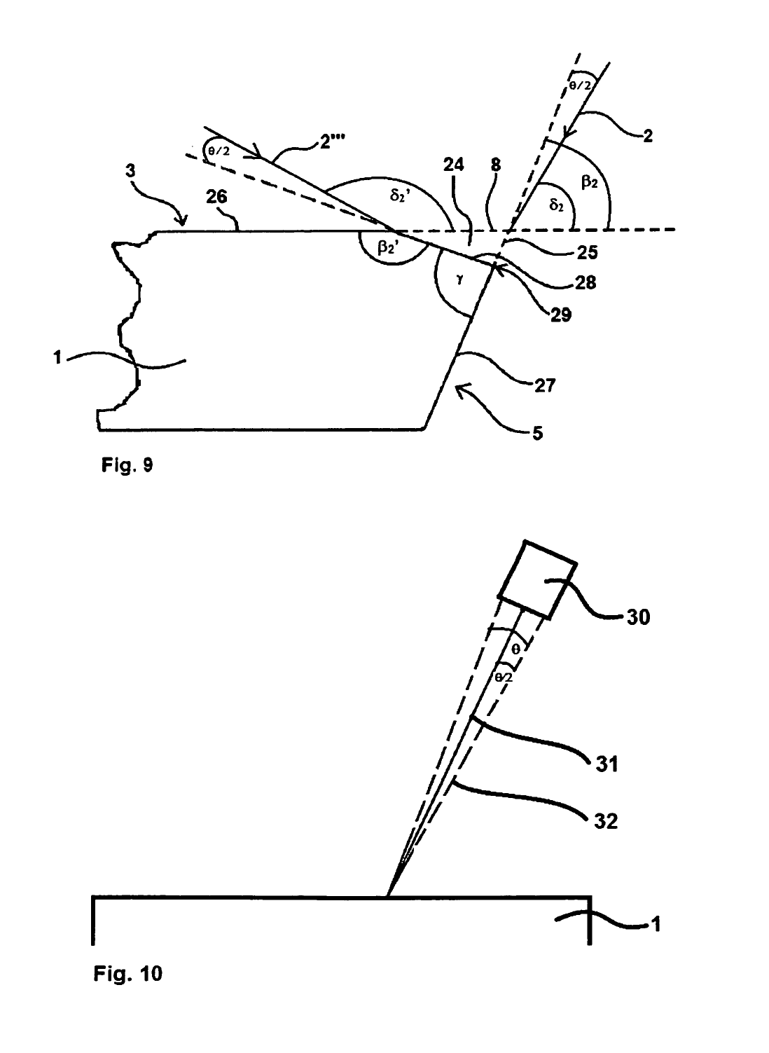

FIG. 9 shows a third model embodiment of the method. With regard to the first material removal process, the third model embodiment corresponds to the first and second model embodiment. The process steps shown in FIGS. 1 and 2 regarding the initial alignment of workpiece 1 and laser beam 2 and the first material removal process are therefore identical in the third model embodiment. The reference numbers corresponding to those for the first model embodiment are the same as for the first model embodiment in the third model embodiment shown in FIG. 9. In the first material removal process the laser beam 2 is aligned at the angle δ₂=β₂−θ/2 relative to the first side surface 3. β₂ is the angle between the side surface 3 on which the removal of material begins and the side surface 5 produced by the removal of material. θ is the opening angle of the laser. The difference between the first and third model embodiment consists of the second alignment of workpiece 1 and laser beam with each other. After the second alignment the laser beam 2′″ strikes the first side surface 3 at an angle of δ₂′=β₂′−θ/2, to be more precise the second section 8 of the first side surface 3. Unlike the first and the second model embodiment, the laser beam 2′″ is directed at the first side surface 3 and not at the second side surface 5 after the second alignment. In the third model embodiment the second material removal process begins on the first side surface 3 and ends on the second side surface 5. In the second material removal process a second section 24 of the workpiece 1 is removed. Part of the second section 8 of the first side surface 3 and an initial section 25 of the second side surface 5 now disappears. There remains a third section 26 of the first side surface and a second section 27 of the second side surface 5. A new third side surface 28 which is adjacent to the third section 26 of the first side surface and to the second section 27 of the second side surface furthermore forms. The edge between the third side surface 28 and the second section 27 of the second side surface 5 is produced at the end of the second material removal process. This is the cutting edge 29. Unlike the first and the second model embodiment, the cutting wedge is formed by the third side section 28 and the second section 27 of the second side surface 5. The angle between the third side surface 28 and the second section 27 of the second side surface 5 is the wedge angle γ.

All features of the invention can be material to the invention both individually and in any combination.

### REFERENCE NUMBERS

1 Workpiece
2 Laser beam for the first material removal process
2′ Laser beam for the second material removal process of the first model embodiment
2″ Laser beam for the second material removal process of the second model embodiment
2′″ Laser beam for the second material removal process of the third model embodiment
3 First side surface of the workpiece
4 Section of the workpiece which is removed in the first material removal process
5 Second side surface of the workpiece
6 Fourth side surface of the workpiece
7 First section of the first side surface
8 Second section of the first side surface
9 First section of the fourth side surface
10 Second section of the fourth side surface
11 Edge between the second section of the first side surface and the second side surface after the first material removal process
12 Second section of the workpiece that is removed in a second material removal process of the first model embodiment
13 Third side surface of the workpiece
14 Third section of the first side surface
15 Second section of the second side surface
16 Cutting edge
17 First section of the second side surface
18 Second section of the workpiece that is removed in a second material removal process of the second model embodiment
19 First section of the second side surface
20 Third section of the first side surface
21 Second section of the second side surface
22 Third side surface
23 Cutting edge
24 Second section of the workpiece that is removed in a second material removal process of the third model embodiment
25 First section of the second side surface
26 Third section of the first side surface
27 Second section of the second side surface
28 Third side surface
29 Cutting edge
30 Laser
31 Beam axis
32 Beam cone

1. Method for machining a workpiece where a laser beam and/or a workpiece are moved relative to each other and a cutting edge is produced on the workpiece by means of the removal of material by laser ablation, comprising the following process steps initial alignment of the workpiece (1) and/or laser beam (2) relative to each other, where the laser beam (2) is directed at a first side surface (3) of the workpiece (1),
initial removal of material from the workpiece (1) by the laser beam (2), where an initial section (4) of the workpiece (1) is removed and a new side surface (5) of the workpiece is produced, second alignment of the workpiece (1) and/or laser beam (2) relative to each other in a different arrangement compared with the initial arrangement of the workpiece (1) and laser beam (2) relative to each other, where the laser beam is directed at the second side surface (5) or the first side surface (3),
second removal of material from the workpiece (1) by the laser beam (2′, 2″, 2′″) where a second section (12, 18, 24) of the workpiece (1) that is smaller than the first section (4) is removed, and a new third side surface (13, 22, 28) is produced, and where the edge that is produced on the third side surface (13, 22, 28) at the end of the second material removal process is the cutting edge (16, 23, 29),
where the laser in the initial and second material removal process is directed at the side surface on which the removal of material begins with its beam axis at an angle of δ<β, where β is the angle between the side surface on which the removal of material begins and the side surface produced by the removal of material.

2. Method according to claim 1, wherein δ≦β−θ/2 applies for angle δ, where θ is the opening angle of the laser beam.

3. Method according to claim 1, wherein the angle δ in essence corresponds to the difference between angle β and half the opening angle of the laser beam.

4. Method according to claim 1, wherein the initial removal of material from the workpiece (1) by the laser beam (2) begins in an initial section (7) of the first side surface (3) and wherein the first section (7) of the first side surface (3) is removed in the initial removal process on the first section (4).

5. Method according to claim 1, wherein the new second side surface (5) is adjacent to a second section (8) of the first side surface (3) remaining after the removal of material.

6. Method according to claim 1, wherein the second removal of material from the workpiece (1) by the laser beam (2′, 2″, 2′″) begins in a first section of the second side surface (5) and continues as far as a second section (8) of the first side surface (3) or vice-versa.

7. Method according to claim 6, wherein part of the second section (8) of the first side surface (3) and a first section (17, 19, 25) of the second side surface (5) are removed in the second removal of material.

8. Method according to claim 1, wherein the third side surface (13, 22, 28) is adjacent to a third section (14, 20, 26) remaining on the first side surface (3) after the second removal of material, and that wherein the third side surface (13, 22, 28) is adjacent to a second section (15, 21, 27) of the second side surface (5) remaining after the second removal of material.

9. Method according to claim 1, wherein the cutting edge is produced either as the edge between the third side surface (13, 22) and the first side surface (3) or as the edge between the third side surface (28) and the second side surface (5).

10. Method according to claim 1, wherein the angle between the second side surface (5) and the second section (8) of the first side surface (3) is greater than 45° and smaller than 120°.

11. Method according to claim 1, wherein the angle α, α₁ or α₂ between the third side surface (13, 22, 28) and the third section (14, 20, 26) of the first side surface (3) and/or the angle γ between the third side surface (13) and the second section (27) of the second side surface (5) is greater than 0° and smaller than 180°.

12. Method according to claim 1, wherein the material is removed in layers by laser ablation.

13. Method according to claim 1, wherein the laser beam (2, 2′, 2″, 2′″) is moved over the workpiece (1) by means of beam guidance.

14. Method according to claim 1, wherein the material for forming the second side surface (5) is removed from the first side surface (3) down to a fourth side surface (6) of the workpiece (1), where the fourth side surface (6) and the first side surface (3) have no common edges.

15. Method according to claim 1, wherein the second and the third side surface (5, 13, 22, 28) acquire the form of flat surfaces by the removal of material.

16. Method according to claim 1, wherein the workpiece (1) after the initial removal of material and before the second removal of material is rotated by an angle of between 60° and 180° relative to the laser beam (2), about an essentially perpendicular axis relative to the beam axis of the laser beam (2) for the initial removal of material.

17. Method according to claim 1, wherein less material is removed by the laser beam in the second material removal process than in the first material removal process.
